(19) United States
(12) Patent Application Publication
(10) Pub. No.: US 2003/0110905 A1
(43) Pub. Date: Jun. 19, 2003

(54) PIPE WRENCH

(76) Inventor: Walter J. Lacey, Alvin, TX (US)

Correspondence Address: Valerie K. Friedrich, 1422 CHESTNUT SPRINGS, Houston, TX, 77062, US

(21) Appl. No.: 10/028,551

(22) Filed: Dec. 19, 2001

(51) Int. Cl. B25B 13/16

(52) U.S. Cl. 81/174

(57) ABSTRACT

A sliding jaw wrench with a movable lower jaw and a stationary upper jaw. The upper jaw is attached to an elongated shank and the bottom portion of the shank is threaded. An opening in the lower jaw piece allows the lower jaw to slide around the threaded shank. A handle with internal threading is screwed onto the threaded portion of the elongated shank thereby pushing up on the lower jaw piece and causing the jaw opening of the wrench to tighten.

### FIELD OF THE INVENTION

The present invention relates to wrenches, and more particularly to sliding jaw type wrenches, such as pipe wrenches. The present invention relates to a pipe wrench with a floating movable lower jar and a stationary upper jaw onto which a handle is rotatably mounted. The handle presses against a lower face of the floating movable lower jaw causing the lower jaw to move toward the upper jaw thereby causing the opening between the upper and lower jaws to change to fit the pipe or other object to be turned or held and permitting the grip of the wrench on the object being turned to tighten during use.

### BACKGROUND OF THE INVENTION

Sliding jaw type wrenches commonly have a movable upper jaw which is formed on an elongated shank. Such prior art wrenches generally have a stationary lower jaw integral with a handle piece. Such prior art sliding jaw wrenches generally utilize a threaded nut coupled to the lower jaw/handle piece into which the elongated shank of the movable upper jaw is threaded. In order to adjust the jaw opening, the nut is turned, thereby engaging the threads on the elongated shank and moving the shank/movable upper jaw piece. To adjust the jaw opening of such prior art wrenches, a user is required to use one hand to hold the wrench handle and to use the other hand o adjust the upward or downward motion of the movable jaw. Other two-handed adjusting mechanisms are also used in the prior art.

In addition to requiring the use of more than one hand, prior art adjusting mechanisms impede the use of gloves, and especially impede the use of thick or ill fitting work gloves. Therefore, such prior art wrenches cannot easily be used in environments which require the use of gloves, such as in the vacuum of space, or in which the use of gloves is desirable, such as under water or in extremes of heat or cold.

Furthermore, prior art sliding jaw wrenches have a tendency to loosen as the wrench is worked on workpiece. Most such prior art sliding jaw wrenches do not utilize locking mechanisms to hold the movable jaw at a set distance from the stationary jaw. Therefore, the movement of the wrench during work often causes the threaded nut to slip resulting in a slippage of the wrench over the workpiece. Certain prior art wrenches utilize a locking mechanism to prevent such slippage. Such locking mechanisms, however, result in more difficult wrench handling, requiring the use of two hands to release and engage the locking mechanism.

There is a need therefore for a sliding jaw type wrench which may be easily operated with a single hand, with gloves, and which does not loosen during use on a workpiece.

### SUMMARY OF THE INVENTION

The invention provides a sliding jaw wrench, such as a pipe wrench, having a stationary upper jaw piece on an elongated shank, a movable lower jaw piece which floats over the elongated shank of the stationary upper jaw piece and a handle, having a hollow, internally threaded portion, which screws onto and over the elongated shank of the stationary upper jaw piece abutting the lower portion of the lower jaw piece such that the opening between the jaws may be changed. In accordance with the present invention, the elongated shank of the stationary upper jaw piece has to opposing threaded faces forming a discontinuous threaded track on which the internal threading of the handle may be threaded. The movable lower jaw piece of the present invnetion has an opening which permits the lower jaw piece to be slidably mounted over the elongated shank of the stationary upper jaw piece. The handle is then threaded onto the threaded portion of the elongated shank of the stationary upper jaw piece. The upper face of the handle then abuts the lower face of the lower jaw piece. Accordingly, the lower jaw piece is moved upward and the jaw opening is decreased by screwing the handle onto the elongated portion of the stationary upper jaw piece.

A wrench in accordance with the present invention may be adjusted with one hand, such that a user need not release his or her grip on the wrench handle in order to adjust the jaw opening or to use one hand to hold the wrench handle while adjusting the jaw opening with the other hand. Furthermore, the wrench of the present invention permits the wrench to be used effectively in all environments, including environments in which gloves may be required or desirable, such as in a vacuum or underwater. In addition to these advantages, the wrench of the present invention more effectively grips workpieces. This advantageous gripping feature arises from the fact that as a user turns the wrench, the user has a natural tendency to turn the handle of the wrench in a direction which causes the movable lower jaw to tighten on the workpiece, thereby easily and automatically tightening the grip of the wrench on the workpiece. Consequently, the wrench of the present invention is particularly suited for uses in which an increasingly tighter grip on the workpiece is desirable, for example, pipes coated with protective coatings or dirtied or soiled with grease or oil.

### BRIEF DESCRIPTION OF THE DRAWINGS

FIG. 1 is a side elevational view of a first preferred embodiment of a pipe wrench of the present invention. The dashed lines indicated portions of the elongated shank 6 which are occluded from view by other parts of the wrench.

FIG. 2 is a side elevational view of the stationary upper jaw piece of a first preferred embodiment of the pipe wrench of the present invention.

FIG. 3 is a side elevational view of the movable lower jaw piece of a first preferred embodiment of the pipe wrench of the present invention.

FIG. 4 is a top elevational view of the movable lower jaw piece of a first preferred embodiment of the pipe wrench of the present invention.

FIG. 5 is a cross-sectional view of the handle of the first preferred embodiment of the pipe wrench of the present invention.

FIG. 6 is a top elevational view of the handle of the first preferred embodiment of the pipe wrench of the present invention.

FIG. 7 is a rear elevational view of a second preferred embodiment of the pipe wrench of the present invention.

FIG. 8 is a side elevational view of a third preferred embodiment of the pipe wrench of the present invention.

### DESCRIPTION OF THE PREFERRED EMBODIMENTS

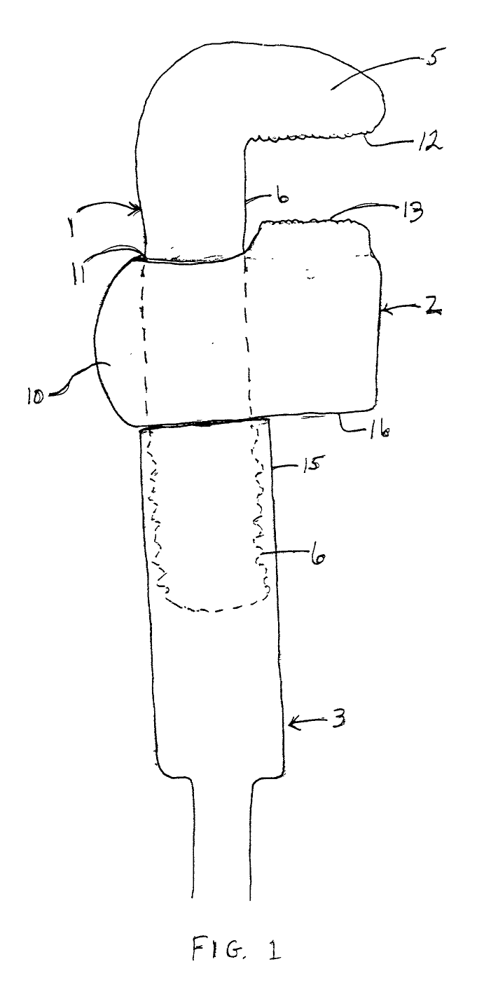

A first preferred embodiment of the pipe wrench is shown in FIG. 1. Referring to FIG. 1, the wrench has a stationary upper jaw piece 1, a slidable lower jaw piece 2, and a handle 3. Stationary upper jaw piece 1 has an upper jaw 5 and an elongated shank 6. Slidable lower jaw piece 2 is slidably mounted onto elongated shank 6 through an opening 11 in a linking end 10 of slidable lower jaw piece 2. Handle 3 is threaded around elongated shank 6 and a top portion 15 of handle 3 abuts against a lower surface 16 of slidable lower jaw piece 2. In the preferred embodiments of the pipe wrench of the present invention, a lower face 12 of upper jaw 5 and an upper face portion 14 of slidable lower jaw piece 2 have corrugations, or teeth, so as to further improve the grip of the wrench on a workpiece.

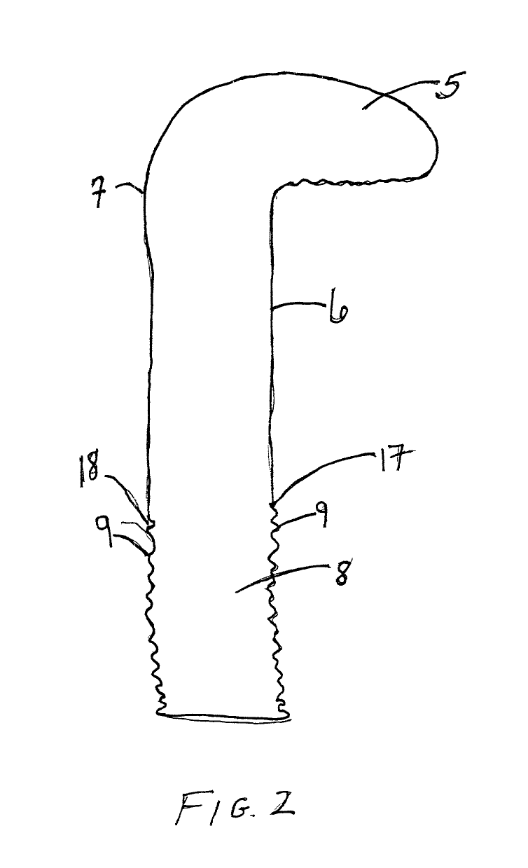

Referring now to FIG. 2, upper jaw 5 extends substantially perpendicularly from a top portion 7 of the elongated shank 6. A bottom portion 8 of elongated shank 6 has external threads 9. Threads 9 may extend around the entire perimeter of bottom portion 8 or may be on only two opposing faces 17 and 18 of bottom portion 8, as shown in FIG. 2. In the preferred embodiments, upper jaw 5 is integrally molded or formed with the elongated shank 6. Alternatively, upper jaw 5 may be a separate component fixedly attached to elongated shank 6. In the preferred embodiment, elongated shank has a substantially rectangular lateral cross section so tat faces 17 and 18 form a threaded track onto which a complimentary threaded member may be screwed. Those skilled in the art will understand that elongated shank 6 may have alternative shapes and threading patterns. It will be further understood that elongated shank 6 may be greased, oiled, or sprayed or coated with lubricants to facilitate the sliding motion of slidable lower jaw piece 2 over elongated shank 6.

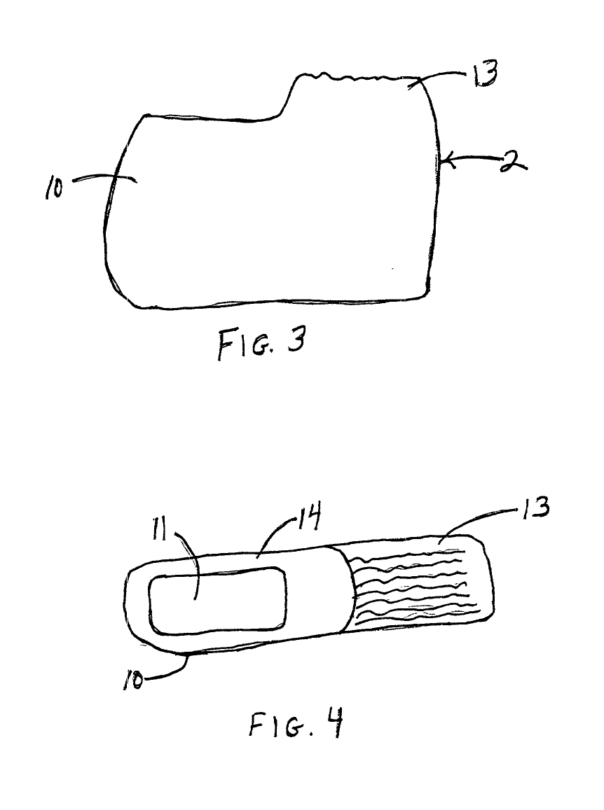

Referring to FIG. 3, the slidable lower jaw piece 2 has a jaw portion 13. Referring to FIG. 4, lower jaw piece 2 has transverse opening 11 passing through a linking end 10 of slidable lower jaw piece 2 from upper face 14 to a lower face 16 (not shown in FIG. 4). It will be understood that opening 11 may have a variety of shapes provided that the shape of opening 11 is complimentary to and fits around the elongated shank 6. In the preferred embodiments, opening 11 is substantially rectangular.

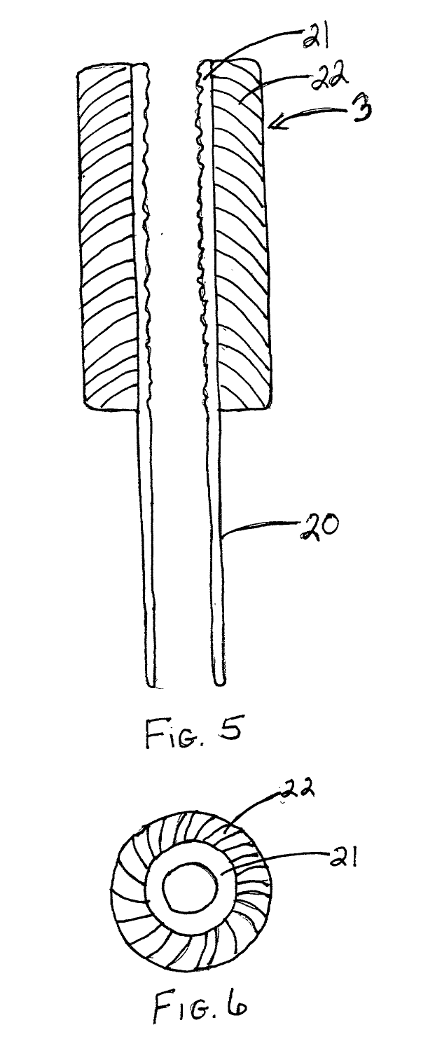

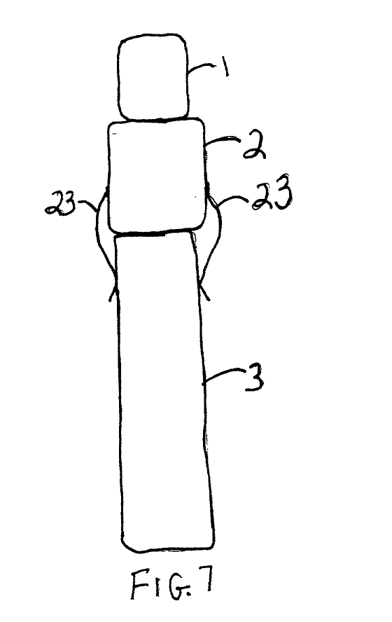

Referring now to FIG. 5, handle 3 may be of any common handle shape, such as tubular or rectangular. In the preferred embodiments, handle 3 is tubular in shape. In embodiments in which handle 3 is not entirely hollow, handle 3 has a hollow tubular portion 21. Hollow tubular portion 21 is internally threaded to receive the threaded bottom portion 8 of elongated shank 6. In the preferred embodiment, hollow tubular portion 21 is surrounded by and fixedly attached to a tubular collar 22. A lower portion 20 of handle 3 is gripped by a user's hand both to adjust the jaw opening and to turn the wrench and the workpiece. It will be understood that lower portion 20 may be modified to more comfortably accommodate a hand. For example, the outer surface of bottom portion 20 may be molded with finger indentations or may be covered by a plastic hand.

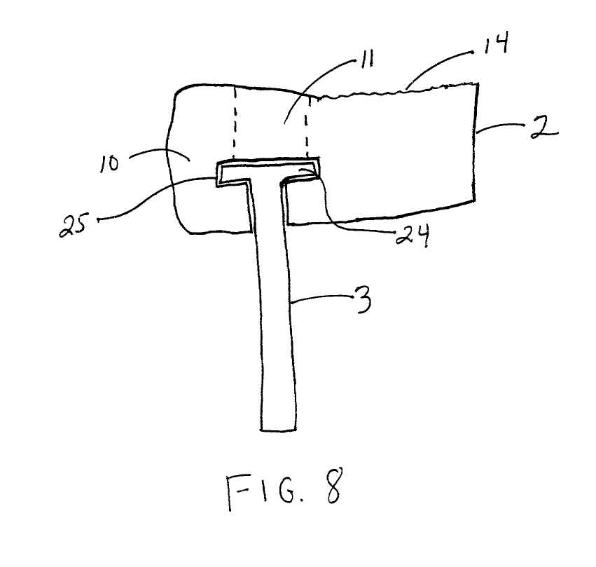

Referring now to FIG. 7, a second preferred embodiment of the pipe wrench of the present invention is shown. In the second preferred embodiment, two or more metal tension clips 23 are fixedly attached to slidable lower jaw piece 2. The unattached ends of metal tension clips 23 extend below slidable lower jaw piece 2 and rest upon the outer surface of either hollow tubular portion 21, or, if present, tubular collar 22. Metal tension clips are spaced so as to provide mutually opposing tension.

Referring now to FIG. 8, a third preferred embodiment of the pipe wrench of the present invention is shown. In the second preferred embodiment, slidable lower jaw piece 2 is interlocked with either hollow tubular portion 21, or, if present, tubular collar 22 by use of a shaped flanged 24 on hollow tubular portion 21 (or tubular collar 22) and a complimentary cutout portion 25 within the opening 11 of slidable lower jaw 2.

I claim:

1. A wrench comprising:
a stationary upper jaw piece comprising:
an elongated shank having an upper portion and a bottom threaded portion and;
an upper jaw extending substantially perpendicularly from said upper portion of said elongated shank;
a slidable lower jaw piece comprising:
a jaw portion and;
a linking portion, said linking portion having a transverse opening, said bottom threaded portion of said elongated shank slidably attached through said transverse opening; and
a handle comprising:
a hollow tubular portion having internal threading complementary to said bottom threaded portion of said elongated shank and said hollow tubular portion screwably attached onto said bottom threaded portion of said elongated shank at a position beneath said slidable lower jaw and;
a lower portion.

2. The wrench of claim 1 wherein a lower surface on said upper jaw of said stationary upper jaw piece has teeth.

3. The wrench of claim 1 wherein an upper surface of said jaw portion of said slidable lower jaw piece has teeth.

4. The wrench of claim 1 wherein the perimeter of said lower portion of said handle is surrounded by a plastic sheath.

5. The wrench of claim 1 wherein the perimeter of said lower portion has finger indentations.

6. The wrench of claim 1 further comprising two or more metal tension clips, each said metal tension clip having an attached end attached to said linking portion of said slidable lower jaw piece and having a second resting against and applying tension to said hollow tubular potion.

7. The wrench of claim 1 further comprising a tubular collar rigidly attached around said hollow tubular portion of said handle.

8. The wrench of claim 7 further comprising two or more metal tension clips, each said metal tension clip having an attached end attached to said linking portion of said slidable lower jaw piece and having a second end resting against and applying tension to said tubular collar.

9. The wrench of claim 1 further comprising:
a shaped flange at a topmost end of said hollow tubular portion; and
a cutout portion within said opening of said slidable lower jaw piece, said cutout portion complementary in shape with said shaped flange and interlocking with said shaped flange.
